(19) United States
(12) Patent Application Publication
(10) Pub. No.: US 2004/0050775 A1
(43) Pub. Date: Mar. 18, 2004

(54) Hollow body

(75) Inventor: Hans Joachim Bassfeld, Wesel (DE)

Correspondence Address: KUSNER & JAFFE, HIGHLAND PLACE SUITE 310, 6151 WILSON MILLS ROAD, HIGHLAND HEIGHTS, OH, 44143, US

(73) Assignee: ENVICON Klartechnik Verwaltungsgesellschaft mbH

(21) Appl. No.: 10/634,293

(22) Filed: Aug. 5, 2003

(30) Foreign Application Priority Data
Aug. 6, 2002 (DE) 102 35 948.2

(51) Int. Cl. B01D 39/20

(52) U.S. Cl. 210/501; 210/506; 210/321.6

(57) ABSTRACT

A hollow body through which a fluid passes that comprises at least one of the following materials:

a material which itself has an antimicrobial effect,

a material in which an additive with biocidic effect is distributed, or

a material onto at least one surface of which a material has a biocidic effect is placed.

### FIELD OF THE INVENTION

The invention relates to a hollow body, through which a fluid may pass and which may be used in sewage (water) treatment devices or drainage systems.

### BACKGROUND OF THE INVENTION

According to this invention hollow bodies are used—i.a.—in sewage water treatment devices, which may be part of a sewage plant. This may be a hollow body through which air is fed, such as a diffusor for providing the necessary oxygene into the waste water. Such diffusors may be equipped with a perforated membrane, through which pressurized oxygene is fed into the water. This oxygene is used to feed the micororganism, present in the sewage water, which microorganism being responsible for recognizing the sewage water ingredients as nutrients and cunsuming same.

A problem is the deposit of these microorganism onto said membrane. This leads to a biological layer onto the surface of said membrane. This biological layer may comprise various bacteria, algae or other organic components. This bio-layer increases continously, thus making the openings in the membrane smaller or even blocking them. This leads to an uncontrolled airflow (air bubbles) and the efficiency of said diffusor device is reduced as well as the air pressure. An unsufficient amount of oxygene may further cause the death of microorganism in the sewage water, thus interrupting the sewage water cleaning-process.

Similar problems may happen in other applications such as with drainage systems. The openings in corresponding drainage pipes may get blocked, thus decreasing the efficiency of such systems.

Similar problems arise with heat exchangers as used in sewage water treatment apparatus when sludge is treated. This sludge is treated under exclusion of air entry by unaerobic microorganism, which consume the sludge, thus preparing water, CO₂ and stabilized sludge unaerobic sludge stabilization). To provide good temperature conditions for said microorganism the sludge is heated by heat exchangers. But here as well is has been noticed that the corresponding heat exchanging zones are filled up with microorganism, causing a sharp decrease in the efficiency of such device.

The described problems are true as well with respect to heat exchangers, provided at the outlet end (exit) of such a plant and used for producing heat by heat pumps, which heat deriving from the cleaned water.

### SUMMARY OF THE INVENTION

It is one object of the invention to provide a hollow body without such problems.

This object is achieved by a hollow body characterized by the features of claim 1, namely such hollow body is made at leat partially of one of the following materials:

which itself has an antimicrobial effect,

including an additive with a biocidic effect,

onto the surface of which a material is placed presenting biocidic effects.

### DETAILED DESCRIPTION OF THE INVENTION

The term “additive with biocidic effect” or “biocidic additive” includes all materials able to kill or consume organism or keep them away from said hollow body. The term organism includes plants, microorganism, the latter including bacteria and fungus.

Because of the the additive with biocidic effect it is prevented to great extent that microorganism settle onto the surface of such hollow body and thus influencing its function in a negative way. This additive may be integrated into the material of the hollow body. One possibility is that the additive in added to the primary material of the hollow body, but without influencing the mechanical properties of the hollow body in any negative way. In order to achieve an effective activity of said biocides in said hollow body they may be dispersed homogenously within the material of the hollow body. In order to achieve its full function the biocide, which may be used in various preparations, i.a. pulverized, cristalline or fluid, must get into contact with the microorganism. This is the reason why predominantly the surface of the hollow body should comprize the boicidic additive. Often it is not necessary to include the additive to the material of the whole hollow body. Mostly it is sufficient if those parts of the hollow body comprise said additive, where negative results may be expected in case microorganism settle in this area.

It may be sufficient, instead of changing the primary material of the hollow body, to add the biocidic material just in the surface area. Insofar the hollow body may be designed with a corresponding surface layer of said biocidic additive. This may be done by common methods such as spraying the additive onto the surface of the hollow body.

As an alternative it is proposed to prepare the hollow body of a material which itself provides antimicrobial behaviour, i.e. offers a protection against microorganism. Contrary to materials being equipped with biocides, as explained above, the antimicrobial behaviour only becomes effective within the material itself, for example a polymere. Microorganism which get into contact with said material are killed (consumed) by the material itself, without giving the active ingredients the possibility to “escape” (get out). Such a material is known under the brand AMINA T 100 and sold by Creavis GmbH, Marl, Germany

This material may also be used as an additive within the first alternative of the invention.

The hollow body may be designed as a diffusor, which may be used in sewage plants for introducing oxygene.

These diffusors may be so called “membrane disk diffusors” which have the shape of a disk or the like, covered by a flexible membrane. Air is fed under pressure in any space between the disk-like support and the membrane. The membranes typically are made of a synthetic material, especially EPDM (a polymeric mixture), whereby the membrane comprises or is made of at least one on the said materials. The polymeric mixture (EPDM) may have the following composition: ethylene-propylene-chains (polymere) about 25-55 wt.-%, soot (C) about 10-30 wt.-%, softeners (paraffines, aromatic and naphtenic mineral oils) about 2-35 wt.-% as well as cross linking and anti oxidizing agents about 1 wt.-%, whereby it sufficient to include only minor amounts of the additive described in order to achieve a biocidic behaviour of the membrane. Oxygene is passed through the perforated membrane, which may comprise corresponding slits, into the water to be treated, whereby the mircoorganism present in the water use said oxygene and consume the further water ingredients. During the blowing process the membrane is deformed, the slits are opened and fine bubbles pass the slits and enter the water.

It is a disadvantage of known diffusors that the softeners (mollifyers), present in the membrane, such a paraffines, aromatic and naphtenic mineral oils, are washed out of the material of the membrane after a certain time of use. This may occur because the microorganism present onto said membrane, liberate said softing agents. Because of said loss of softing agents the membrane gets stiffer and stiffer. At the same time the pressure decreases and the costs increase so that the membrane must be replaced.

These disadvantages may be avoided according to the invention. There is no layer of microorganism formed onto the surface of said membrane (at least less), so that loss of softening agents is characteristicly reduced. Any microorganism are consumed much faster Oxygene may introduce the sewage water in a much more homogenous way, as less microorganism settle in the area on the slits of the membrane.

The diffusor may be a membrane tube diffusor (perforated pipe covered by a membrane). Here as well the biocidic additive may be part of the material of the diffusor, which hinders microorganism to deposit onto the surface or in the openings for said oxygene entrance. It is further possible to prepare a layer of said biocidic agent onto said surface or to use said material with antimicrobial behaviour.

In a further embodiment the hollow body is designed as a drainage pipe, equipped with openings, through which water may flow into the ground. Is is a disadvantage of such known drainage pipes that the openings get blocked during use so that an efficient draining is no longer possible. According to the invention this will not happen any more.

The material including (comprising) or carrying the biocodic material onto its surface may be a plastic (sythetic) material. The biocidic components may be mixed in when the synthetic material is prepared and shaped. This is possible as well with respect to drainage pipes made of plastic. The pipe may be made of polyvinylchloride (PVC). The biocidic material may be integrated or placed onto the surface.

According to one further embodiment the drainage pipe is covered by a further “cover” the latter again compring, made of or carrying onto its surface the described material. The cover which may be flexible and made—for example—of mineral fibres, is used as a wrapping material for said drainage pipe to prevent the pipe from entry of sludge. Further the cover takes care that no microorganism settle onto said drainage pipe or its openings respectively. If drinking water is to be fed along the drainage pipe it is important to avoid any bacteria and fungus to grow in the openings, which task may be achieved with the invention. It is possible as well to design the drainage pipe and its cover as described.

The hollow body may further be a heat exchanger. If such a heat exchanger, made of or covered at least partially by the described material, is used in a sewage basin during sludge treatment no or at least less deposit of a layer including microorganism is observed. In this context it is important that the heat exchange areas correspond to the inventive concept, i e are made of a material or covered by a material as described. The heat exchanger may also be covered by a separate element as described above with respect to the drainage system.

Biocidic polymeres which may be integrated in polyethylene (PE) or polypropylene (PP) respectively may be used as an additive. It is an advantage of these additives that they keep away microorganism from the surface, while such biocidic additives cannot be washed out (get off) so that there is no risk of any contamination of the environment. The additive is active without any time limit.

The additive may comprise a material based on silverzeolites. This additive has the advantage that is active as well under water over a long time period as the silver ions, being part of the zeolite structure, cannot get off (pass away). This additive (material) is active especially against algae, moss and bacteriae.

According to a further embodiment the additive may comprise a material based on silver ions, which is characterized—like the biocidic polymeres—by the advantage that it cannot be separated (“washed out”) except under specific conditions. These additive may be used with success against the formation and growth of bacteriae, yeast, mould and fungus. It is a further advantage that these additives may be used in nearly all synthetic materials, whereby the characteristics of such synthetic materials are amended only very little.

A further additive may be polyvinylpyrrole or polyvinylazole. As an example this material can be used in preparing a surface layer of the hollow body.

The biocidic additive may be used in an amount of 0.5 to 50 wt.-% with respect to the total mass of the respective part and being dependent—i.a.—of the concentration/purity of the additive. The additive may be used in parts of 0.5 and 25 wt.-%. Silverzeolites in a 20% concentration may be used in an amount of between 0.5 and 10 wt.-%. Such a material is marketed under the brand IRGAGUARD by Ciby Speciality Chemicals Inc.

Having described the invention, the following is claimed

1. Hollow body through which a fluid may pass, comprising at least one of the following materials:
a) a material which itself has an antimicrobial effect,
b) a material in which an additive with biocidic effect is distributed,
c) a material, onto at least one surface of which a material having a biocidic effect is placed.

2. Hollow body according to claim 1, the surface of which is covered by said additive with the biocidic effect.

3. Hollow body according to claim 1, wherein the biocidic additive has been sprayed onto the surface

4. Hollow body according to claim 1, wherein the material with antimicrobial effect is a polymere.

5. Hollow body according to claim 1, designed as a diffusor.

6. Hollow body according to claim 1, designed as a membrane disk diffusor including a membrane.

7. Hollow body according to claim 1, the membrane of which is made of a synthetic material made of at least one of the materials mentioned in claim 1.

8. Hollow body according to claim 1, designed as a membrane tube diffusor.

9. Hollow body according to claim 1, designed as a drainage pipe

10. Hollow body according to claim 1, whereby the biocidic additive is distributed within a synthetic material or placed on the surface of a synthetic material.

11. Hollow body according to claim 1, covered by a cover, comprising the biocidic additive or presenting itself an antibacterial effect.

12. Hollow body according to claim 11, the cover of which is made predominantly of mineral fibers or a polymeric material.

13. Hollow body according to claim 1, designed as a heat-exchanger.

14. Hollow body according to claim 1, the additive of which comprises biocidic polymeres.

15. Hollow body according to claim 1, the additive of which comprises a material based on silver zeolites.

16. Hollow body according to claim 1, the additive of which is a material based on silver ions.

17. Hollow body according to claim 1, the additive of which comprises polyvinylpyrrole.

18. Hollow body according to claim 1, the additive of which is a material which itself has antimicrobial effects.

19. Hollow body according to claim 1, with 0.1 to 50 wt.-% of the biocidic additive, related to the total mass of that part of the body, comprising the additive.
